(19) United States
(12) Patent Application Publication
(10) Pub. No.: US 2021/0303368 A1
(43) Pub. Date: Sep. 30, 2021

(54) OPERATOR MANAGEMENT APPARATUS, OPERATOR MANAGEMENT METHOD, AND OPERATOR MANAGEMENT COMPUTER PROGRAM

(71) Applicant: Hitachi, Ltd., Tokyo (JP)

(72) Inventors: Jiye YU, Tokyo (JP); Keisuke HATASAKI, Tokyo (JP); Yuki NAGANUMA, Tokyo (JP); Takaya IDE, Tokyo (JP)

(21) Appl. No.: 17/018,864

(22) Filed: Sep. 11, 2020

(30) Foreign Application Priority Data
Mar. 24, 2020 (JP) 2020-052489

(51) Int. Cl. G06F 9/50; G06F 9/455; G06F 17/18; G06F 11/32

(52) U.S. Cl. CPC G06F 9/5077; G06F 9/5027; G06F 2009/45591; G06F 17/18; G06F 11/324; G06F 9/45558

(57) ABSTRACT

This invention is, in an application system, to grasp a status of a resource and to facilitate a management of the application in a container orchestration platform, by determining a corresponding relation between an operator and a resource. An operator management apparatus of the present invention includes an application system construction unit which designates a configuration of the application system including a set of operators, a resource management unit which acquires resource information about a set of resources generated by the set of operators, and a relation determination unit which, using a feature value of a first operator included in the set of operators and the resource information, calculates a probability at which a first resource included in the set of resources corresponds to the first operator to thereby determine the corresponding relation between the first operator and the first resource.

### CROSS-REFERENCE TO RELATED APPLICATIONS

The present application claims priority to Japanese Patent Application No. 2020-052489, filed Mar. 24, 2020. The contents of this application are incorporated herein by reference in their entirety.

### BACKGROUND

The present invention relates to an operator management apparatus, an operator management method, and an operator management computer program.

A container orchestration technique has recently been attracting attention while the spread of cloud computing increases. The container orchestration is a technique of managing imaginary partitioning “container” of operating environments of an application on an OS (Operating System). By using the container orchestration, a user such as a company or the like is capable of utilizing various functions of increasing efficiency of the management of an application, such as deploying the container, monitoring the operating status of the container, etc.

As an example of the container orchestration platform, there is mentioned, for example, Kubernetes. The Kubernetes is an open-source container orchestration system for automatizing deployment and scaling and managing a containerized application.

### SUMMARY

In Kubernetes described in Non-Patent Document 1 (“Operator pattern”. [online]. Kubernetes, Sep. 8, 2019. [retrieved on Mar. 9, 2020]. Retrieved from the Internet: <URL: https://kubernetes.io/docs/concepts/extend-kubernetes/operator/>, the containerized application is executed in an application system including one or plural application operators (hereinafter called “operators”) and resources generated by the operators, thereby making it possible to manage packaging, deployment, etc. of the application.

In the current Kubernetes, however, a corresponding relation between an application operator and a resource (e.g., a secondary resource or the like generated by a custom resource) belonging to the application operator is not managed. Therefore, in particular, a large-scale application system including many operators may have difficulty in grasping the status of a specific resource.

Therefore, the present invention aims to provide an operator management apparatus which determines a corresponding relation between an operator and a resource on the basis of a feature value of each operator configurating one application system and information obtained about a resource which belongs to the operator to thereby grasp the status of the resource and facilitate the migration of an application to a container orchestration platform such as Kubernetes or the like and the management of the application.

In order to solve the above problems, a typical operator management apparatus of a container orchestration platform according to the present invention includes an application system construction unit which designates a configuration of an application system including a set of operators, a resource management unit which acquires resource information about a set of resources generated by the set of operators, and a relation determination unit which using a feature value of a first operator included in the set of operators and the resource information, calculates a probability at which a first resource included in the set of resources corresponds to the first operator to thereby determine a corresponding relation between the first operator and the first resource.

According to the present invention, there can be provided an operator management apparatus which determines a corresponding relation between an operator and a resource on the basis of a feature value of each operator configurating one application system and information obtained about a resource which belongs to the operator to thereby grasp the status of the resource and facilitate the migration of an application to a container orchestration platform such as Kubernetes or the like and the management of the application.

### BRIEF DESCRIPTION OF THE DRAWINGS

FIG. 1 is a block diagram showing an example of a computer system configured to execute an operator managing means according to an embodiment of the present invention;

FIG. 2 is a diagram showing an example of an overall flow of the operator managing means according to the embodiment of the present invention;

FIG. 3 is a diagram showing an example when an application system is constructed using a system construction unit according to the embodiment of the present invention;

FIG. 4 is a diagram showing an example of a manifest about the application system according to the embodiment of the present invention;

FIG. 5 is a diagram showing an example of the application system according to the embodiment of the present invention;

FIG. 6 is a diagram showing an example of a first information management table according to the embodiment of the present invention;

FIG. 7 is a diagram showing an example of a second information management table according to the embodiment of the present invention;

FIG. 8 is a diagram showing an example of the flow of an operator management method according to the embodiment of the present invention;

FIG. 9 is a diagram showing a graph of a numerical formula used in a correspondence relation determination according to the embodiment of the present invention;

FIG. 10 is a diagram showing an example of a means for verifying a corresponding relation between an operator and a resource according to the embodiment of the present invention;

FIG. 11 is a diagram showing an example of an output result by an operator management tool according to the embodiment of the present invention;

FIG. 12 is a diagram showing an example of the flow of event detecting processing by the operator management tool according to the embodiment of the present invention;

FIG. 13 is a diagram showing an example where event detecting processing is executed on the application system according to the embodiment of the present invention; and

FIG. 14 is a diagram showing another example where event detecting processing is executed on the application system according to the embodiment of the present invention.

### DETAILED DESCRIPTION

A related art example and an embodiment of the present invention will hereinafter be described with reference to the accompanying drawings. Incidentally, the present invention is not limited by the present embodiment. Further, in the description of the drawings, the same parts are designated by the same reference numerals.

(Container Orchestration)

As described above, the container orchestration is a technique of managing imaginary partitioning (container) of operating environments of an application on an OS (Operating System). Running each application as a container makes it possible to implement a plurality of containers operated on a single physical server, for example in independent server environments and manage them.

There is however a problem in that when the number of containers to be managed is increased while it is possible for the containers to construct development/execution environments with ease, their operation/management becomes complex and thereby take time. The container orchestration solves this problem. The use of the container orchestration makes it possible to automatically perform deploying, scaling, management, etc. of a containerized application. A container orchestration tool having these functions is provided as OSS (Open Source Software such as Kubernetes or the like) or a commercial product.

By using the above-described container orchestration, a user such as a company or the like is capable of utilizing various functions of efficiently performing management of applications, such as deploying a container, monitoring an operating status of the container, etc. For example, when the user designates the utilization rate of a CPU or a memory, etc., a container orchestration platform operates an application under the condition of the CPU utilization rate designated by the user. Thus, when the CPU utilization rate exceeds a predetermined reference value, the container orchestration platform automatically scales the application to lower the utilization rate to within a preferred range.

In general, the container orchestration platform manages at least one cluster configured of a master node and a worker node. The master node is a component group responsible for the operation and management of the container orchestration platform. The worker node serves as a deploy destination for a container cluster. When a developer or an operation manager instructs the master node through the use of an instruction, the developer or the operation manager is capable of assigning a pod (group of one or more application containers) to the worker node and managing the status of the pod by API related to the operation/management of the master node.

Also, the worker node is created in plural as needed and operated. The worker node may be configured of, in addition to the pod, a component which has a role of a proxy or a load balancer, or a component operated and managed by the worker node in cooperation with the master node, etc.

Further, as described above, the application system in the container orchestration platform includes at least one operator. The operator described herein corresponds to a software extension which utilizes a resource for managing an application and a component of a third party. Using the operator makes it possible to extend the behavior of a cluster without correcting the source code of the container orchestration platform.

The operator is capable of executing various functions according to the status or purpose of the application system, such as deploying an application, acquiring the backup of the status of the application, performing changes of a database schema, additional settings and modifications, etc. simultaneously with the updating of an application code, performing simulation at the time of an operation or abnormality in a cluster, etc.

Further, the operator in the application system includes a Custom Resource Definition Object (CRD Object) which defines a custom resource creatable by the operator. In general, the term “resource” is an end point of API of a container orchestration plat form, which holds the correction of a specific API object, and the custom resource is an extension of API to add the function of a custom, which cannot be used in a container orchestration platform by default.

The operator first creates the custom resource defined by CRD of the operator as the top resource each time the operator creates the resource. Further, after the customer resource (hereinafter also called a “primary resource”) is created, the custom resource creates a secondary resource such as Deployment, StatefulSet or the like.

As an example, in the case of an operator of Nginx, the operator first creates a resource of Nginx as the primary resource defined by CRD, and thereafter the Nginx being the primary resource may create Deployment or the like as a secondary resource.

However, in the current container orchestration platform as described above, the corresponding relation between an application operator and a resource (e.g., a secondary resource generated by a primary resource) which belongs to the application operator is not managed with respect to all operators. Therefore, in particular, a large-scale application system including many operators may have difficulty in grasping the status (such as being in operation, the presence of an abnormality, etc.) of a specific primary resource.

Incidentally, the term “corresponding” described herein means that some kind of association exists between one operator or resource and another operator or resource in the application system. It can be said that for example, a certain operator and a resource generated by the corresponding operator correspond to each other. Further, the term “associating” means that information indicative of association existing between one operator or resource and another operator or resource is managed in some kind of data management table in the application system.

Further, in principle, a primary resource is associated with an operator having created the primary resource (that is, the information indicative of the association is managed in the application system), but a secondary resource created by a primary resource is not associated with the primary resource having created the secondary resource (that is, the information indicative of the association is not managed in the application system). Therefore, the corresponding relation between the operator and the secondary resource is unknown, and a difficulty arises in confirming the status of a resource which belongs to a specific operator.

Accordingly, in order to grasp the status of the primary resource, there is a need to determine the corresponding relation between the application operator and the resource (i.e., the secondary resource or the like generated by the primary resource) which belongs to the application operator.

Thus, the operator managing means according to the embodiment of the present invention calculates a probability at which a specific secondary resource corresponds to a specific operator, on the basis of a feature value of an operator configuring a certain application system and information acquired about a resource which belongs to the operator, thereby making it possible to determine the corresponding relation between the operator and the secondary resource. Further, there can be provided an operator management apparatus which by using the determined corresponding relation between the operator and the secondary resource, grasps the status of the secondary resource and makes it easy to migrate an application to the container orchestration platform such as Kubernetes and manage the application.

(Hardware Configuration)

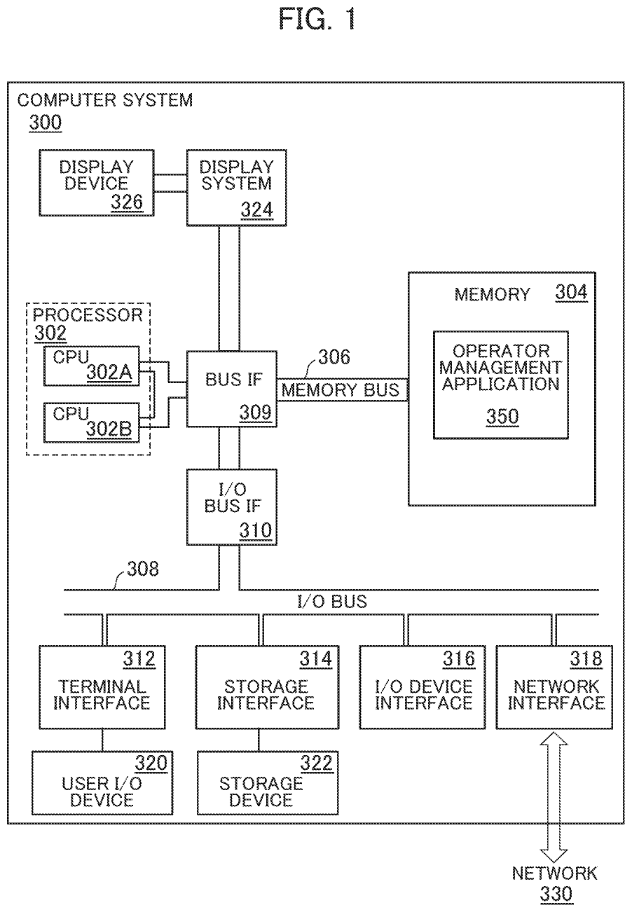

A computer system 300 for implementing the embodiment of the present disclosure will first be described with reference to FIG. 1. Mechanisms and devices of various embodiments disclosed in the present specification may be applied to any suitable computing system. Main components of the computer system 300 include one or more processors 302, a memory 304, a terminal interface 312, a storage interface 314, an I/O (Input/Output) device interface 316, and a network interface 318. These components may be connected to one another through a memory bus 306, an I/O bus 308, a bus interface unit 309, and an I/O bus interface unit 310.

The computer system 300 may include one or plural general-purpose programmable central processing units (CPUs) 302A and 302B collectively called the processor 302. In one embodiment, the computer system 300 may include a plurality of processors, whereas in another embodiment, the computer system 300 may be a signal CPU system. Each processor 302 may execute an instruction stored in the memory 304 and include an onboard cache.

In one embodiment, the memory 304 may include a random access semiconductor memory, a storage device, or a storage medium (either volatile or non-volatile) for storing data or programs. The memory 304 may store all or part of programs, modules, and data structures which perform functions to be described in the present specification. For example, the memory 304 may store an operator management application 350. In one embodiment, the operator management application 350 may include an instruction or description for executing functions to be described later on the processor 302.

In one embodiment, the operator management application 350 may be executed in hardware through a semiconductor device, a chip, a logic gate, a circuit, a circuit card, and/or another physical hardware device instead of or in addition to a process-based system. In one embodiment, the operator management application 350 may include data other than the instruction or description. In one embodiment, a camera, a sensor, or another data input device (not shown) may be provided to directly communicate with the bus interface unit 309, the processor 302, or another hardware of the computer system 300.

The computer system 300 may include the bus interface unit 309 which performs communication among the processor 302, the memory 304, the display system 324, and the I/O bus interface unit 310. The I/O bus interface unit 310 may be linked to the I/O bus 308 for transferring data between various I/O units. The I/O bus interface unit 310 may communicate with the plural I/O interface units 312, 314, 316, and 318 each also known as an I/O processor (IOP) or an I/O adapter (IOA) through the I/O bus 308.

The display system 324 may include a display controller, a display memory, or both of them. The display controller can provide video, audio, or both data of them to the display device 326. Further, the computer system 300 may include one or plural devices such as sensors or the like configured to acquire data and provide the data to the processor 302.

For example, the computer system 300 may include a biometric sensor which acquires heart rate data, stress level data, etc., an environment sensor which acquires humidity data, temperature data, pressure data, etc., and a motion sensor which acquires acceleration data, motion data, and the like, etc. Sensors of types other than these may also be used. The display system 324 may be connected to the display device 326 such as a single display screen, a television, a tablet, or a portable device or the like.

The I/O interface unit has the function of communicating with various storages or I/O devices. For example, the terminal interface unit 312 can be attached with a user I/O device 320 like a user output device such as a video display device, a speaker television or the like, and a user input device such as a keyboard, a mouse, a keypad, a touch pad, a track ball, a button, a light pen, or the other pointing device. The user may operate the user input device by using the user interface to input input data and instructions to the user I/O device 320 and the computer system 300 and receive output data from the computer system 300. The user interface may be displayed on the display device through the user I/O device 320, reproduced by a speaker, or printed through a printer, for example.

The storage interface 314 can be attached with one or plural disc drives and directly with an access storage device 322 (which is normally a magnetic disc drive storage device, but may be an array of disc drive configured to be assumed as a single disc drive, or another storage device). In one embodiment, the storage device 322 may be implemented as an arbitrary secondary storage device. The content of the memory 304 may be stored in the storage device 322 and read from the storage device 322 as needed. The I/O device interface 316 may provide an interface to another I/O device such as a printer, a fax machine, or the like. The network interface 318 may provide a communication path so that the computer system 300 and other devices can communicate mutually. This communication path may be a network 330, for example.

In one embodiment, the computer system 300 may be a device which receives a request from another computer system (client), having no direct user interface, such as a multiuser main frame computer system, a single user system, or a server computer, or the like. In another embodiment, the computer system 300 may be a desktop computer, a portable computer, a notebook personal computer, a tablet computer, a pocket computer, a telephone, a smartphone, or any other suitable electronic device.

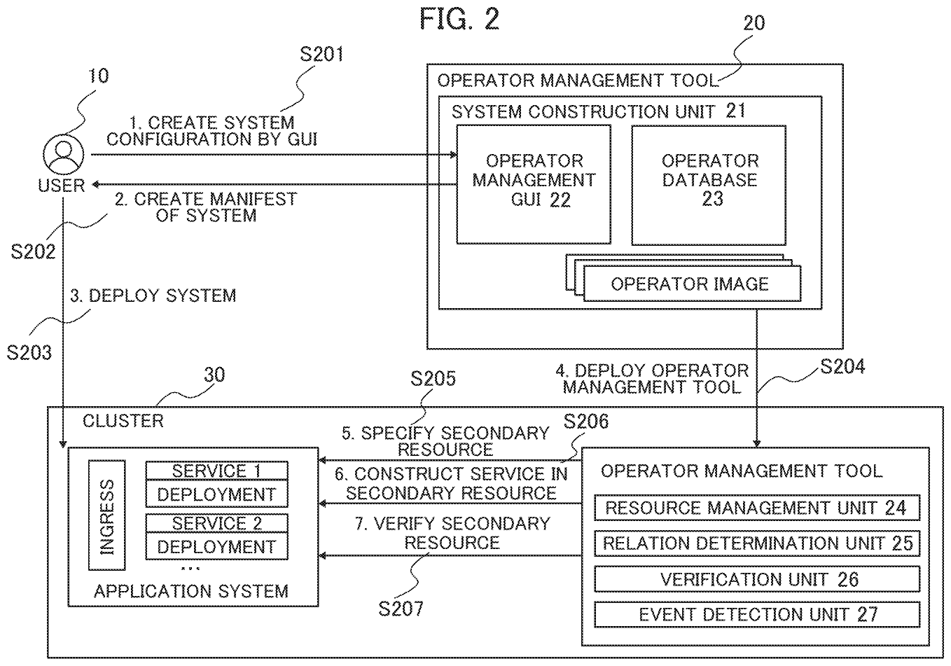

A description will next be made about the overall flow of the operator managing means according to the embodiment of the present invention with reference to FIG. 2.

FIG. 2 is a diagram showing an example of the overall flow of the operator managing means according to the embodiment of the present invention. As shown in FIG. 2, the operator managing means according to the embodiment of the present invention is mainly executed by a user 10, an operator management tool 20, and a cluster 30 in a container orchestration platform.

The user 10 is a user who designs an application system mounted in the cluster 30 of the container orchestration platform.

The operator management tool 20 is a software application for executing the function of the operator managing means according to the embodiment of the present invention. As will be described later, the operator management tool 20 may include, for example, an application system construction unit 21 which specifies the configuration of an application system including a set of operators, a resource management unit 24 which acquires resource information about a set of resources generated by the set of operators, a relation determination unit 25 which using a feature value of a first operator included in the set of the operators and the resource information, calculates a probability at which a first resource included in the set of resources corresponds to the first operator, to thereby determine a corresponding relation between the first operator and the first resource, a verification unit 26 which verifies the corresponding relation between the resource and the operator, and an event detection unit 27 which detects an event relative to the application system.

The cluster 30 is a set of node machines (e.g., a master node and a worker node) for running a containerized application in the container orchestration platform. The cluster 30 is configured to automatically manage the containerized application under a designated desired condition.

First, in Step S201, the user 10 designates the configuration of the application system through the application system construction unit 21 of the operator management tool 20. Here, the user 10 may construct the configuration of a desired application system by using an operator management GUI 22 and an operator database 23 included in the application system construction unit 21, for example.

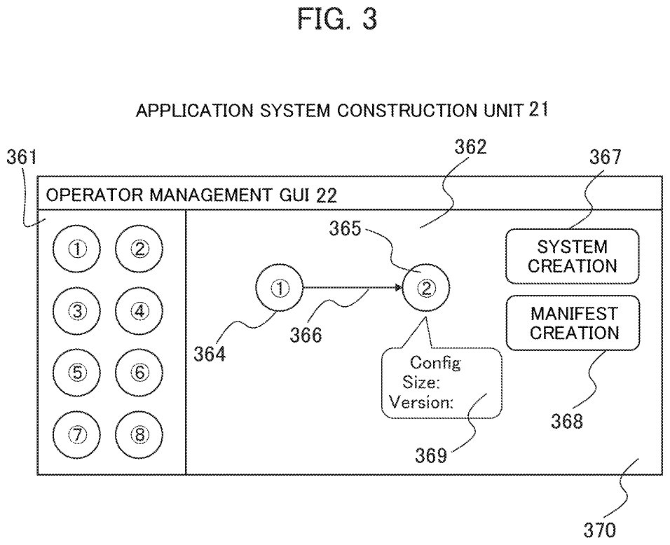

Incidentally, the processing of designating the configuration of the application system using the operator management GUI 22 and the operator database 23 will be described with reference to FIG. 3.

Next, in Step S202, the user 10 will get a system manifest generated by operator management tool according to the application system designated in Step S201. In general, the system manifest described herein is an API object description for generating, changing, and deleting pods, deployment, service, ingress, an operator, etc. in the container orchestration platform. Here, in terms of each operator included in the application system, the user 10 may create a manifest describing the attribute of the operator.

Next, in Step S203, the user 10 deploys the application system to the container orchestration platform. Here, the term “deploy” means that the designated application system is implemented in the desired cluster 30 in the container orchestration platform. For example, the user 10 may select a cluster which satisfies the condition of a resource (a CPU, a memory or the like) required for operating the application system and implement the application system in the selected cluster.

Next, in Step S204, the operator management tool 20 is deployed to the container orchestration platform. Here, the operator management tool 20 is deployed to the same cluster (e.g., the cluster 30) as the cluster where the application system is deployed in Step S203.

Next, in Step S205, in terms of each operator in the application system, the operator management tool 20 specifies a secondary resource corresponding to the operator. More specifically, the resource management unit 24 of the operator management tool 20 acquires resource information about a resource generated by each operator. Thereafter, the relation determination unit 25 calculates a probability at which a specific resource corresponds to a specific operator by using a feature value of the operator and the acquired resource information to thereby determine a corresponding relation between each operator and the resource.

Incidentally, the details of this processing will be described later.

Next, in Step S206, the operator management tool 20 assigns a service to each resource on the basis of the corresponding relation between the operator and the resource, which has been determined in Step S205. The service described herein is a method of in the container orchestration platform, opening an application run in a set of pods and a resource of the application as network services. In other words, the service designates a means for accessing a specific resource. Here, the service is assigned to the resource to thereby enable communication between the resource and another resource in the container orchestration platform.

Next, in Step S207, the operator management tool 20 verifies the corresponding relation between the operator and the resource, which has been determined in Step S205. More specifically, the verification unit 26 of the operator management tool 20 confirms whether the resources each assigned with the service in Step S206 can communicate with each other, to thereby verify whether the corresponding relation determined as to these resources is correct.

Incidentally, the details of this processing will be described later.

According to the operator managing means described above, the operator management apparatus can be provided which determines the corresponding relation between the operator and the resource on the basis of the feature value of the operator configuring one application system and the information obtained about the resource which belongs to the operator to thereby grasp the status of the resource and facilitate the migration of the application to the container orchestration platform and the management of the application.

An example when the application system is constructed using the system construction unit according to the embodiment of the present invention will next be described with reference to FIG. 3.

FIG. 3 is a diagram showing the example when the application system is constructed using the system construction unit according to the embodiment of the present invention.

As described above, the user is capable of designating the configuration of the application system through the application system construction unit 21 of the operator management tool. More specifically, the user selects and arrange a desired operator in the operator management GUI 22 of the application system construction unit 21 to thereby make it possible to construct an application system having a desired configuration.

As shown in FIG. 3, the operator management GUI 22 is comprised of an operator selection area 361 and an operator arrangement area 362. A candidate operator used for the construction of the application system is displayed in the operator selection area 361. The operator displayed in the operator selection area 361 may be the operator stored in the operator database shown in FIG. 2, for example.

The user of the operator management GUI 22 selects the operator desired to be used for the configuration of the application system from the operator selection area 361 and arranges the selected operator in the operator arrangement area 362 by operations such as drag and drop.

After the selected operator is arranged in the operator arrangement area 362, the user may draw an arrow between operators to designate the flow of data between the operators. As shown in FIG. 3, for example, the user may draw an arrow 366 directing from an operator “1” 364 to an operator “2” 365 after having arranged the operator “1” 364 and the operator “2” 365 to thereby set the operator “2” 365 as an operator downstream of the operator “1” 364.

Incidentally, as an example, the operator “1” 364 may be “Nginx” which functions as a gateway, and the operator “2” 365 may be “Keycloak” for user authentication.

Further, the user is capable of in terms of each operator arranged in the operator arrangement area 362, creating configuration information (config) 369 about the operator. The configuration information described herein may be information describing various attributes such as the capacity of a specific operator, a software version, etc.

The user is capable of selecting the operator arranged in the operator arrangement area 362 and thereby inputting the configuration information 369 of the selected operator.

After inputting the configuration information about each operator arranged in the operate arrangement area 362, the user presses a system creation button 367 to bring the constructed application system into a deployable status (such as execution of its packaging). Further, the user may create a manifest about the constructed application system by pressing a manifest creation button 368.

By using the above-described operator management GUI 22, the user is capable of easily constructing the application system desired to be implemented in the container orchestration platform.

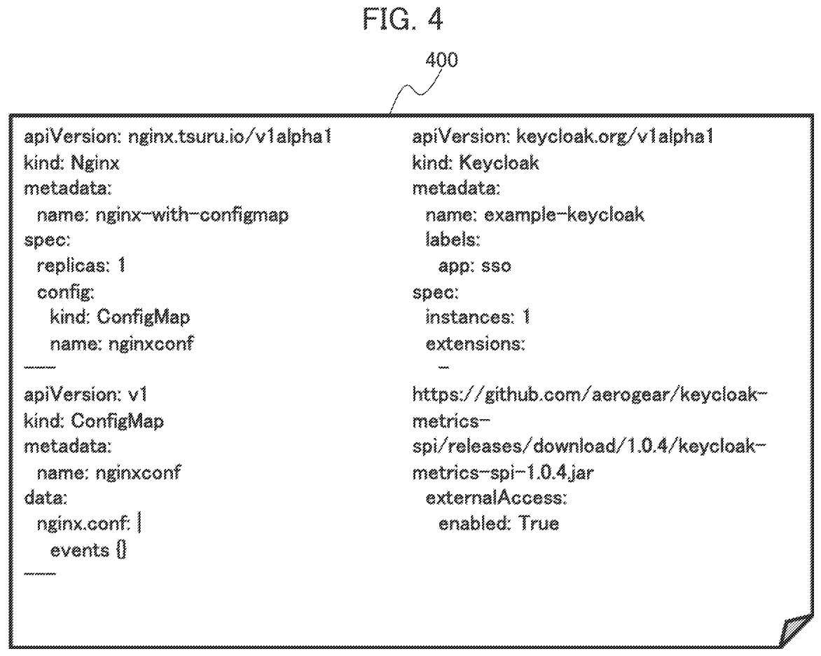

The manifest about the application system according to the embodiment of the present invention will next be described with reference to FIG. 4.

FIG. 4 is a diagram showing an example of the manifest 400 about the application system according to the embodiment of the present invention. As described above, the manifest described herein is an API object description for generating, changing, and deleting pods, deployment, service, ingress, an operator, etc. in the container orchestration platform.

The manifest 400 is description information which defines the attribute of each operator with respect to the operators in the application system generated by the operator management GUI 22 shown in FIG. 3, for example. In terms of the above-described operators such as “Nginx”, “Keycloak”, etc. as shown in FIG. 4, for example, the manifest 400 may define attributes such as the version, kind, metadata, name, specification, replica number, and the like of each operator.

As described above, the user may create the manifest 400 about the application system through the operator management GUI. For example, the user may edit each item described in the manifest 400 or upload another file (file of .yaml or the like) used as the manifest 400.

As to the specific resource as will be described later, the time difference between the time when the resource is created and the time when the manifest 400 is applied is used in calculations for determining the corresponding relation between the operator and the resource. Incidentally, here, the term “applying the manifest” means that the attribute defined in the manifest is applied to the operator and the resource, etc. included in the application system.

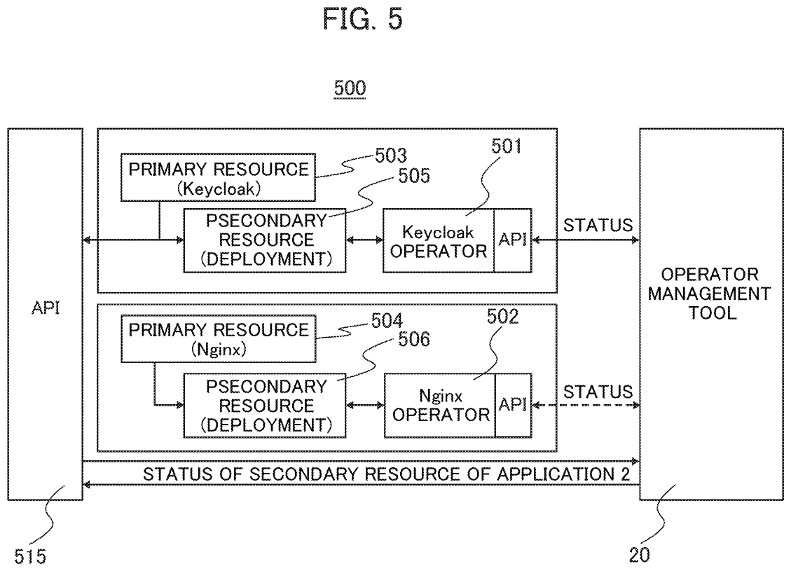

A description will next be made about an example of the application system according to the embodiment of the present invention with reference to FIG. 5.

FIG. 5 is a diagram showing the example of the application system according to the embodiment of the present invention. As described above, in the current container orchestration platform, the corresponding relation between the operator and the resource (e.g., the secondary resource generated by the primary resource, or the like) belonging to the application operator is not managed with respect to all operators. Therefore, in particular, a large-scale application system including a lot of operators may have difficulty in grasping the status of a specific primary resource (such as being in operation, the presence of an abnormality, etc.). An example of this problem will hereinafter be described with reference to FIG. 5.

The application system 500 shown in FIG. 5 includes two operators of a Keycloak operator 501 and an Nginx operator 502. Further, the Keycloak operator 501 and the Nginx operator 502 respectively generate primary resources according to CRD. For example, the Keycloak operator 501 generates a primary resource Keycloak 503, and the Nginx operator 502 generates a primary resource Nginx 504. Further, the primary resource Keycloak 503 and the Nginx operator 502 respectively generate secondary resources. As shown in FIG. 5, for example, the primary resource Keycloak 503 generates a secondary resource 505 of deployment, and the primary resource Nginx 504 generates a secondary resource deployment 506.

Incidentally, these operators and resources are managed by API 515 of the container orchestration platform and the operator management tool 20.

The Keycloak operator 501 includes an API which notifies the status of the corresponding secondary resource unlike the Nginx operator 502. Therefore, the operator management tool 20 is capable of acquiring the status of the secondary resource 505 corresponding to the Keycloak operator 501.

Since, however, the API of the Nginx operator 502 is not intended to notify the status of the corresponding secondary resource, the API cannot easily acquire the status of the secondary resource corresponding to the Nginx operator 502, and hence the operator management tool 20 must make a request of its status acquisition to the API 515 of the container orchestration platform.

Thus, as described above, in the present invention, the operator management apparatus can be provided which calculates the probability at which the specific secondary resource corresponds to the specific operator, on the basis of the feature value of each operator configuring the application system and the information obtained about the resource which belongs to the operator, to thereby grasp the status of the resource and facilitate the migration of the application to the container orchestration platform and the management of the application.

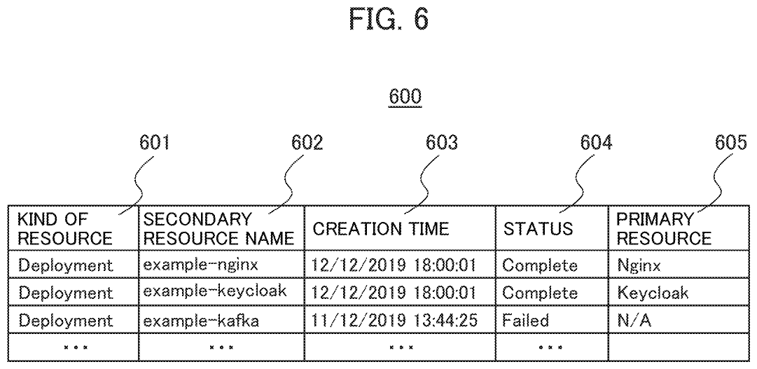

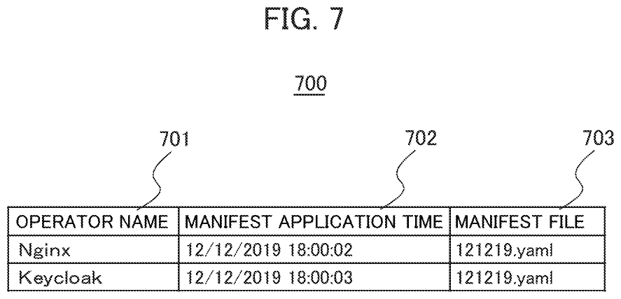

A first information management table and a second information management table according to the embodiment of the present invention will next be described with reference to FIGS. 6 and 7.

FIG. 6 is a diagram showing an example of the first information management table 600 according to the embodiment of the present invention. As described above, in the present invention, in order to determine the corresponding relation between the operator and the secondary resource, the feature value (e.g., the time taken to generate the secondary resource, the name of the primary resource, or the like) of each operator configuring the application system, and the information obtained about the resource which belongs to the operator are used. The first information management table 600 shown in FIG. 6, and the second information management table 700 shown in FIG. 7 are respectively data tables which store part of the information used to determine the corresponding relation between the operator and the secondary resource.

As shown in FIG. 6, the first information management table 600 includes a resource kind 601 indicative of the kind (Deployment, StatefulSet or the like) of a secondary resource, a secondary resource name 602 indicative of the name of the secondary resource, a creation time 603 indicative of the time when the secondary resource is created, a status 604 indicative of the current status of the secondary resource, and a primary resource 405 indicative of a primary resource to which the secondary resource corresponds.

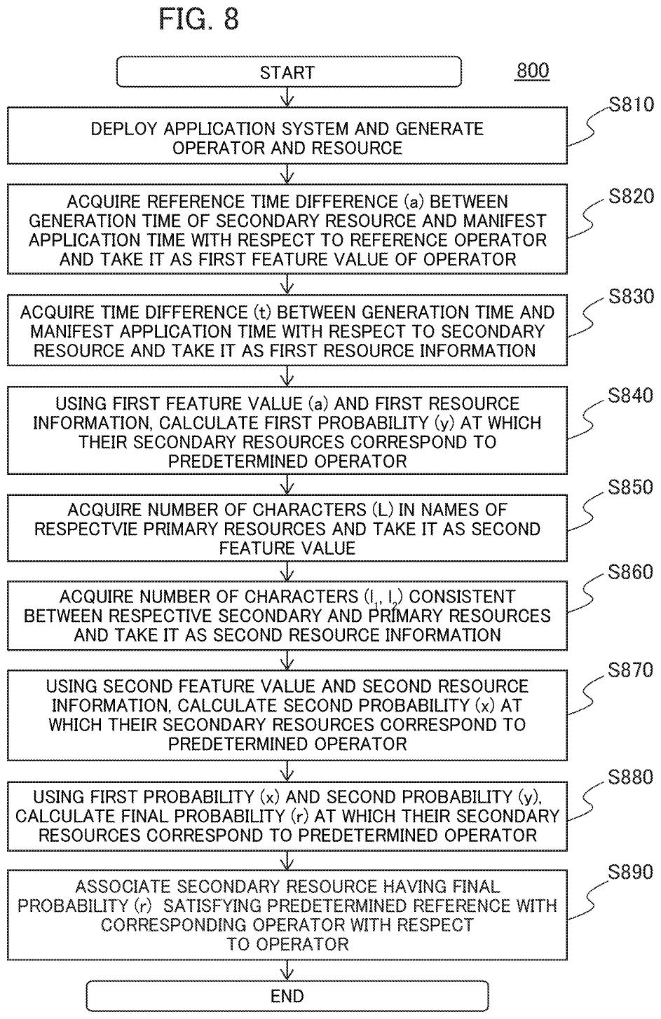

Incidentally, the status of the secondary resource and the information of the corresponding primary resource are described in the first information management table 600 shown in FIG. 6. However, in fact, the status of the secondary resource and the information of the corresponding primary resource are information obtained by executing processing for a corresponding relation determination described with reference to FIG. 8, and are not yet described in the first information management table 600 at a stage before the execution of the processing for the corresponding relation determination.

FIG. 7 is a diagram showing an example of the second information management table 700 according to the embodiment of the present invention. As shown in FIG. 7, the second information management table 700 includes an operator name 701 indicative of the name of each operator, a manifest application time 702 indicative of the time when a manifest is applied to the operator, and a manifest file 703 indicative of a file of the applied manifest.

Incidentally, the first information management table 600 shown in FIG. 6 and the second information management table shown in FIG. 7 may be stored in, for example, a database (not illustrated in the drawing) accessible to the operator management tool according to the embodiment of the present invention.

By using the information included in the first information management table 600 shown in FIG. 6 and the second information management table shown in FIG. 7 both of which are described above, the corresponding relation between the operator and the secondary resource can be determined as will be described later.

The flow of an operator management method according to the embodiment of the present invention will next be described with reference to FIG. 8.

FIG. 8 is a diagram showing an example of the flow of the operator management method 800 according to the embodiment of the present invention. As described above, the operator management method 800 shown in FIG. 8 is executed to thereby make it possible to grasp the status of the resource in the application system and easily perform the migration of the application to the container orchestration platform and the application management.

Incidentally, each Step of the operator management method 800 to be described below may be performed by the operator management tool described with reference to FIG. 2, for example.

First, in Step S810, the application system is deployed to the container orchestration platform to generate an operator and a resource. More specifically, the application system constructed by the application system construction unit 21 described with reference to FIG. 3, for example is deployed to a specific cluster of the container orchestration platform, and hence each operator generates a primary resource defined by CRD. The primary resource may generate a secondary resource.

Further, at this time, the manifest of the application system may also be applied. When the manifest is applied, the operator management tool measures the time when the manifest file is applied with respect to each operator (and/or each resource) and stores it in the above-described second information management table 700.

Next, in Step S820, the operator management tool acquires, in terms of a reference operator at which the corresponding relation with the secondary resource is already grasped in the deployed application system, a reference time difference (first time difference) between a generation time of a secondary resource generated by a primary resource of the operator and a manifest application time when the manifest is applied, and takes the reference time difference (a) as a first feature value of the operator.

Incidentally, the reference time difference (a) between the generation time of the secondary resource and the manifest application time when the manifest is applied is a parameter which depends on the attribute (specification, usable computing resource, or the like) of a host (physical machine or virtual machine) implemented with the operator. Therefore, as long as the attribute of the host remains unchanged, the reference time difference (a) between the generation time of the secondary resource and the manifest application time when the manifest is applied is a constant value and differs for each operator implemented in a different host, and hence it becomes an attribute which characterizes the operator.

Here, in order to acquire the reference time difference (a), for example, in regard to the operator and the secondary resource at which the corresponding relation is already grasped, the generation time when the secondary resource is generated is recorded in the first information management table shown in FIG. 6, and the manifest application time when the manifest is applied is recorded in the second information management table shown in FIG. 7, and thereafter the difference between these generation time and manifest application time may be calculated. Further, this calculation is performed plural times for each operator, and thereafter the average of plural measured values may be set as the reference time difference (a).

Next, in Step S830, when a secondary resource at which a corresponding relation with an operator is not grasped is generated in the deployed application system, the operator management tool acquires a time difference (t) (second time difference) between a generation time of the secondary resource and a manifest application time when a manifest is applied, and takes it as first resource information. Since the first resource information described herein differs for each secondary resource, it becomes an attribute which characterizes the secondary resource.

Next, in Step S840, using the reference time difference (a) being the first feature value acquired in Step S820, and the time difference (t) being the first resource information acquired in Step S830, the operator management tool calculates a first probability (y) at which their respective secondary resources correspond to a predetermined operator in accordance with the following numerical formula 1.

### Numerical Formula 1:

$$y = {e}^{- \frac{{( t - α )}^{2}}{2}} ( t \geq 0 )$$

In the numerical formula 1, when the reference time difference (a) and the time difference (t) become the same value, the first probability (y) becomes the maximum. That is, it can be said that when the time difference (t) between the generation time of the predetermined secondary resource and the manifest application time coincides with the reference time difference (a) between the generation time when the primary resource of the predetermined operator generates the secondary resource, and the manifest application time when the manifest is applied, these operator and secondary resource correspond to each other.

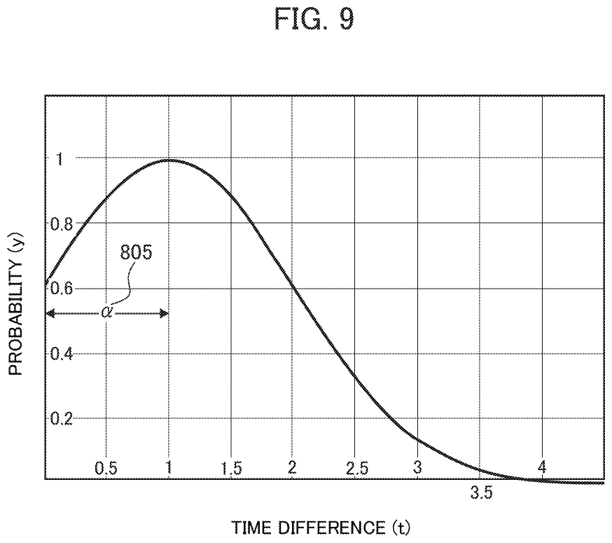

FIG. 9 is a diagram showing a graph of the numerical formula (equation 1) used for the determination of the corresponding relation according to the embodiment of the present invention. As described above, when the reference time difference (a) 805 and the time difference (t) become the same value, the first probability (y) becomes the maximum.

For example, as to an operator A at which a corresponding relation with a secondary resource is already grasped, when the reference time difference (a) between the generation time of a secondary resource generated by a primary resource of the operator A and the manifest application time when a manifest is applied is “1”, and the time difference (t) between the generation time of a predetermined secondary resource B and the manifest application time when a manifest is applied is “1”, the first probability (y) at which the secondary resource B corresponds to the operator A becomes “1” of the maximum value.

Next, in Step S850, in the deployed application system, the operator management tool acquires the name of each primary resource and determines the number of characters (L) in the name. Thereafter, the operator management tool takes the determined number of characters (L) in name as a second feature value of an operator.

More specifically, here, the operator management tool may acquire the name of the primary resource described in CRD of each operator. As an example, when CRD of the operator is “keycloak”, the operator management tool counts the characters of “keycloak” and sets the number of characters (L) in the name as “8”.

Incidentally, in principle, when the primary resource generates the secondary resource, the name of the generated secondary resource is high in similarity to the name of the primary resource having generated it. Further, the name of the primary resource described in CRD of the operator is constant and differs for each operator. Therefore, it becomes an attribute which characterizes a specific operator. Thus, the number of characters consistent between the name of the primary resource and the name of the secondary resource is used, thereby making it possible to calculate a probability at which a predetermined secondary resource corresponds to a predetermined primary resource and operator.

Next, in Step 860, the operator management tool determines the number of characters (hereinafter called “matched character number”) consistent between the secondary resource and the primary resource. Thereafter, the operator management tool sets the determined matched character number as second resource information.

More specifically, here, the operator management tool determines the number of characters consistent between the name of the secondary resource and the name of the primary resource acquired in Step S850 and takes it to be a first matched character number (l₁). Further, the operator management tool determines the number of characters consistent between the label of the secondary resource and the name of the primary resource acquired in Step S850 and takes it to be a second matched character number (l₂). Here, the first matched character number (l₁) and the second matched character number (l₂) are collectively called “second resource information”.

For example, as an example, when the name of the primary resource acquired in Step S850 is “keycloak”, the name of the secondary resource is “Example-keycloak”, and the label of the secondary resource is “app.containerorchestration.io/instance=example-keycloak”, the determined number of characters in name (L) becomes “8”, the first matched character number (l₁) becomes “8”, and the second matched character number (l₂) becomes “8”.

Next, in Step S870, using the second feature value (i.e., the number of characters (L) in the name of the primary resource) of the operator acquired in Step S850, and the second resource information (i.e., the number of characters (l₁, l₂) consistent between the secondary resource and the primary resource) acquired in Step S860, the operator management tool calculates a second probability (x) at which their respective secondary resources correspond to a predetermined operator in accordance with the following numerical formula 2.

### Numerical Formula 2:

$$x = \frac{{( {l}_{1} + {l}_{2} )}^{2}}{4 {L}^{2}}$$

In the numerical formula 2, the second probability (x) becomes the maximum as the first matched character number (l₁) and the second matched character number (l₂) come closer to the number of characters (L) in the name of the primary resource (incidentally, l₁, l₂≤L). That is, it can be said that the larger the number of characters consistent between the name of the secondary resource and the primary resource, the higher the probability at which the secondary resource corresponds to the primary resource (and the operator having generated the primary resource).

Next, in Step S880, using the first probability (y) calculated in Step S860 and the second probability (x) calculated in Step S870, the operator management tool calculates the final probability (r) (third probability) at which each secondary resource in the application system corresponds to each operator, in accordance with the following numerical formula 3.

Numerical Formula 3:

r_{i,j}=yⱼ·x_{i,j}

where i indicates a predetermined operator and j indicates a predetermined secondary resource.

In Step S890, the operator management tool associates with each other, a pair of the operator and the secondary resource which achieves the final probability (r) satisfying a predetermined reference. The predetermined reference described herein may be a value which designates the minimum required probability. For example, the predetermined reference may be an appropriately-selected value such as “85% or more” or the like.

By executing the above-described operator management method 800, it is possible to grasp the status of the resource in the application system and easily perform the migration of the application to the container orchestration platform such as Kubernetes or the like and the management of the application.

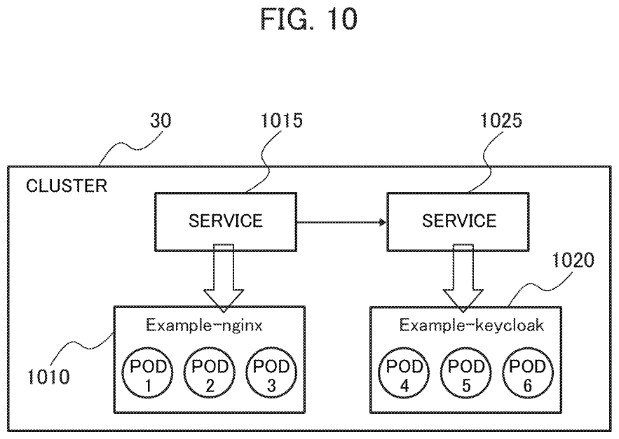

A description will next be made about a means verifying the operator/resource corresponding relation according to the embodiment of the present invention with reference to FIG. 10.

FIG. 10 is a diagram showing an example of the means which verifies the operator/resource corresponding relation according to the embodiment of the present invention. By verifying the operator/resource corresponding relation by a means to be described below, it is possible to confirm whether the operator/resource corresponding relation determined by the above-described operator management method is correct.

After the corresponding relation between the operator and the secondary resource is determined by the above-described operator management method, the verification unit (e.g., the verification unit 26 of the operator management tool shown in FIG. 2) then assigns a service to the secondary resource at which the corresponding relation with the operator is determined.

As described above, the service described herein is a method of in the container orchestration platform, opening the application run in the set of pods and the resource of the application as the network services. As long as association with the proper operator is taken, the secondary resources (i.e., being configured so that they can transmit and receive data each other) connected to each other in the application system should be able to communicate through the assigned services. Thus, it can be confirmed that the corresponding relation between the mutually-connected secondary resources and operators is correctly determined by verifying whether the secondary resources are able to communicate.

An example will be described with reference to FIG. 10, for instance. In the cluster 30, the verification unit of the operator management tool assigns a service 1015 to a secondary resource nginx 1010 and assigns a service 1025 to a secondary resource 1020 of keycloak. Incidentally, here, the secondary resource 1010 and the secondary resource 1020 are resources associated with operators connected to each other in the application system.

After the services have been assigned to the secondary resources 1010 and 1020 respectively, the verification unit causes the secondary resource 1010 to transmit test data to the secondary resource 1020. Thereafter, the verification unit confirms whether the secondary resource 1020 can safely receive the test data transmitted by the secondary resource 1010. When the secondary resource 1020 has received the test data safely, the verification unit determines that the corresponding relation between the secondary resources 1010 and 1020 and the operators is correct. Further, when it is not possible for the secondary resource 1020 to safely receive the test data (in the cases such as when it is not possible to receive it within a predetermined time, etc.), the verification unit determines the corresponding relation between the secondary resource 1010 or the secondary resource 1020 and the operators to be incorrect (that is, the corresponding relation between the secondary resource 1010 and the operator, the corresponding relation between the secondary resource 1020 and the operator, or both of them are not correct).

Incidentally, when the corresponding relation between the secondary resource and the operator is determined to be incorrect, the operator management tool runs again the operator management method described with reference to FIG. 8, for example, and may determine the corresponding relation between the operator and the secondary resource anew.

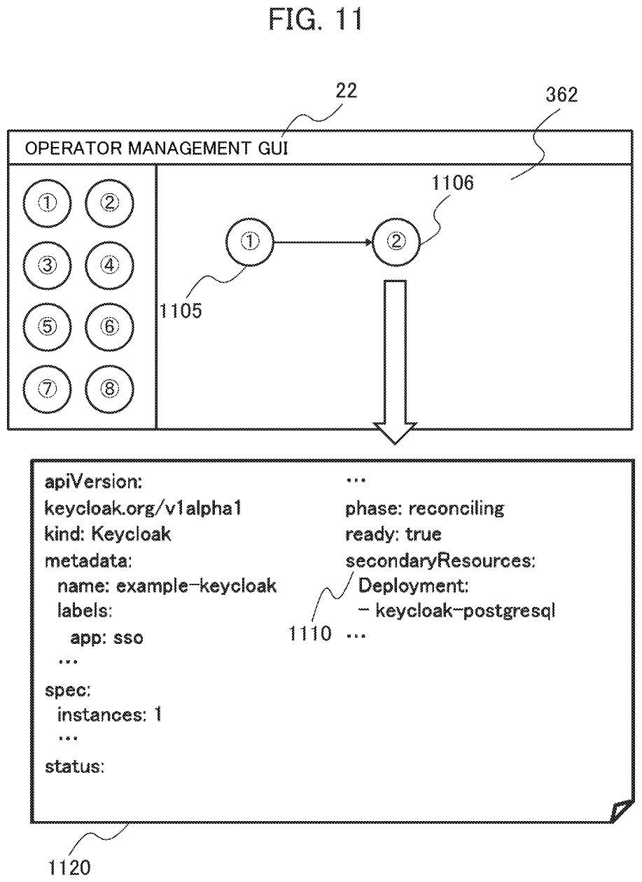

An example of an output result by the operator management tool according to the embodiment of the present invention will next be described with reference to FIG. 11.

FIG. 11 is a diagram showing the example of the output result by the operator management tool according to the embodiment of the present invention. After verifying the operator/resource corresponding relation described with reference to FIG. 10 is executed, and the operator/resource corresponding relation is determined to be correct, the operator management tool visualizes the verified corresponding relation between the operator and the secondary resource and provides it in the form that the user can confirm it.

For example, the operator management tool may display the corresponding relation between the operator and the secondary resource on the operator management GUI 22. More specifically, as to operators 1105 and 1106 arranged in an operator arrangement area 362 of the operator management GUI 22, the operator management tool may create an operator/resource information file 1120 including secondary resource information 1110 (the name of the secondary resource, the current status thereof, etc.) corresponding to the operators. The operator/resource information file 1120 may be, for example, a yaml file. Further, the operator/resource information file 1120 created with respect to a specific operator may be displayed by selecting the operator in the operator management GUI 22 by the user.

Thus, as to the respective operators in the application system, the user is able to easily confirm the secondary resource corresponding to each of the operators and information about the status of the secondary resource.

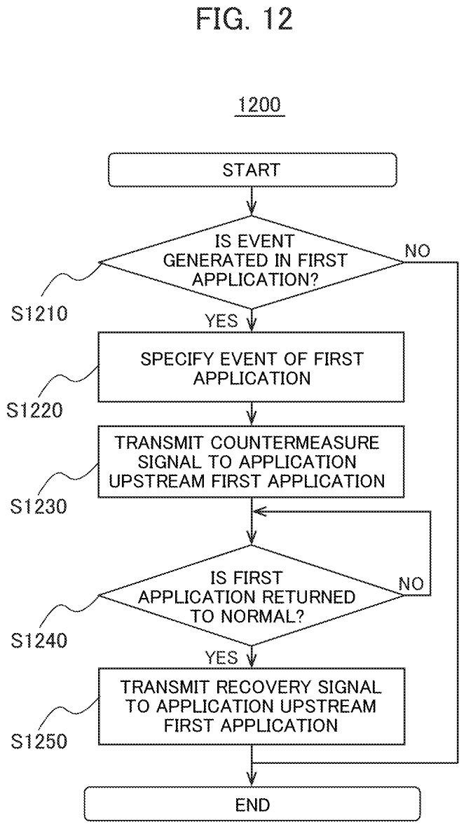

An event detection by the operator management tool according to the embodiment of the present invention will next be described with reference to FIGS. 12 to 14.

FIG. 12 is a diagram showing an example of the flow of event detecting processing 1200 by the operator management tool according to the embodiment of the present invention. As described above, the operator management tool according to the embodiment of the present invention has an event detection unit (for example, the event detection unit 27 shown in FIG. 2) for detecting an event in the application system and taking a countermeasure against the event.

After it is possible for the operator management method described with reference to FIG. 8 to determine the corresponding relation between the operator and the secondary resource and confirm the status of the secondary resource, the event detection unit is capable of determining using the status of the secondary resource whether the event occurs with respect to a predetermined application (i.e., one or plural operators) and implementing a countermeasure. The flow of the event detecting processing 1200 by the event detection unit will hereinafter be described.

First, in Step S1210, the event detection unit determines whether an event occurs with respect to a predetermined application (hereinafter also called a “first application”). The event described herein is intended to change the status of an application, an operator, or a resource (i.e., to change it from a first status to a second status). For example, the event may be updating to the first application (such as firmware updating or the like) or may be an abnormality such as a failure or the like. Here, in order to determine whether the event is generated, the event detection unit may confirm the status of each operator configuring the first application, and the status of primary and secondary resources each corresponding to the operator. Here, when it is determined that the event has occurred with respect to the first application (the status of any of the operator, the primary resource, and the secondary resource is not normal), the present processing proceeds to Step S1220. When it is not determined that the event has occurred with respect to the first application, the present processing is ended.

Next, in Step S1220, the event detection unit specifies the event for the first application. Specifically, the event detection unit analyzes the status of the operator, the primary resource, or the secondary resource determined not to be normal in Step S1210 to identify what event has been generated. For example, here, the event detection unit may determine the generated event to be “firmware updating”, or an “error in secondary resource”, or the like.

Next, in Step S1230, the event detection unit transmits a countermeasure signal to an application upstream the first application in the application system. Here, the term “application upstream the first application” means an application configured to transmit data to the first application in the application system (for example, the application system configured by the operator management GUI 22 shown in FIG. 3). If the application upstream the first application is sending data to the first application as usual where an event (updating, error) has occurred with respect to the first application, the data may not be processed correctly. Therefore, in order to prevent the occurrence of an error due to it, it is desirable to transmit a countermeasure signal for changing the behavior of the application upstream the first application. The countermeasure signal described herein may be, for example, a signal which stops the transmission of the data for the upstream application, a signal which changes a destination for the transmission of the data for the upstream application to another application, or a signal which sets the upstream application to a so-called “sorry server”.

Next, in Step S1240, the event detection unit determines whether the first application is returned to normal. Here, the event detection unit analyzes the status of the operator, primary resource, or secondary resource having specified the event in Step S1220 and confirms whether the status is brought into normal. When it is determined that the status of the first application is returned to normal, the present processing proceeds to Step S1250. Further, when it is not determined that the status of the first application is returned to normal, the event detection unit repeats the check of Step S1240 after waiting for a prescribed time (30 seconds, one minute, 20 minutes) or the like.

Next, in Step S1250, the event detection unit transmits a recovery signal to the application upstream the first application. The recovery signal described herein is a signal which returns the application upstream the first application to settings as usual. For example, the recovery signal may be, for example, a signal which resumes data transmission of an application in which the data transmission has been stopped, or a signal which changes the transmission destination for the application whose transmission destination is changed to another application, to the first application.

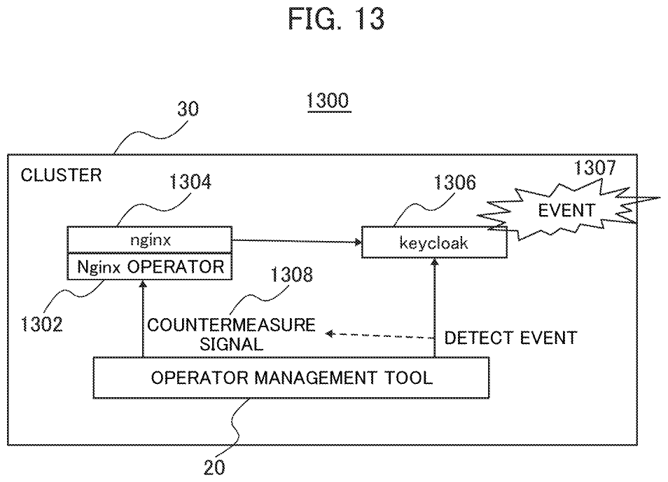

FIG. 13 is a diagram showing an example in which event detecting processing is executed on an application system 1300 according to the embodiment of the present invention. As shown in FIG. 13, a cluster 30 in the application system 1300 includes an operator management tool 20, an operator 1302 managed by the operator management tool 20, a primary resource 1304 corresponding to the operator 1302, and a secondary resource 1306.

Incidentally, since the secondary resource 1306 receives data from the operator 1302 as indicated by an arrow in FIG. 13, the operator 1302 corresponds to an operator (application) upstream the secondary resource 1306.

When the event detection unit (i.e., the event detection unit included in the operator management tool) detects that an event (updating, an error or the like) 1307 is generated with respect to the secondary resource 1306, the event detection unit transmits a countermeasure signal 1308 to the operator 1302 being the operator upstream the secondary resource 1306. The countermeasure signal 1308 may be, for example, a signal which stops data transmission of the operator 1302 to the secondary resource 1306.

Further, when it is determined that the status of the secondary resource 1306 is returned to normal, the event detection unit may transmit a recovery signal (not shown) to undo the transmission of the operator 1304 being the operator upstream the secondary resource 1306.

With the execution of the event detecting processing described above, it is possible to detect the event generated with respect to the application and perform the countermeasure by using the status of the secondary resource.

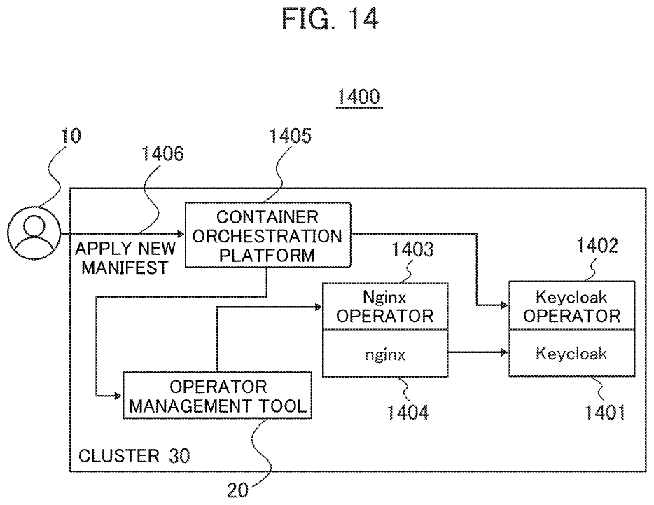

FIG. 14 is a diagram showing another example where event detecting processing is executed on an application system 1400 according to the embodiment of the present invention. More specifically, FIG. 14 is a diagram showing an example of processing when a secondary resource (e.g., keycloak) 1401 of one operator (e.g., a keycloak operator) 1402 is updated (firmware-updated) in a cluster 30 implemented with a container orchestration platform 1405.

When the user 10 applies a new manifest 1406 to the container orchestration platform 1405, the above-described operator management tool 20 (i.e., the event detection unit included in the operator management tool) detects that an event is generated with respect to a secondary resource (e.g., the secondary resource 1401) updated by the new manifest 1406.

Thereafter, the operator management tool 20 may issue an instruction to stop data transmission to the secondary resource 1401, of nginx 1404 being a resource corresponding to an Nginx operator 1403 being an operator upstream the secondary resource 1401 updated by the new manifest 1406, to the Nginx operator 1403. Thus, it is possible to prevent the occurrence of an error due to the incorrect processing of data while the secondary resource 1401 is updated.

Further, the operator management tool 20 may detect that the updating to the secondary resource 1401 is finished and the secondary resource 1401 is returned to the normal state, and may issue to the Nginx operator 1403 being the operator upstream the secondary resource 1401, an instruction to resume data transmission of nginx 1404 being the resource corresponding to the Nginx operator 1403 to the secondary resource 1401.

According to the embodiment of the present invention described above, there can be provided an operator management apparatus which determines a corresponding relation between an operator and a resource on the basis of a feature value of each operator configurating one application system and information obtained about a resource which belongs to the operator to thereby grasp the status of the resource and facilitate the migration of an application to a container orchestration platform such as Kubernetes or the like and the management of the application.

Although the embodiment of the present invention has been described above, the present invention is not limited to the above-described embodiment, and various modifications can be made within the scope not departing from the spirit of the present invention.

What is claimed is:

1. An operator management apparatus of a container orchestration platform, comprising:
an application system construction unit which designates a configuration of an application system including a set of operators;
a resource management unit which acquires resource information about a set of resources generated by the set of operators; and
a relation determination unit which, using a feature value of a first operator included in the set of operators and the resource information, calculates a probability at which a first resource included in the set of resources corresponds to the first operator to thereby determine a corresponding relation between the first operator and the first resource.

2. The operator management apparatus according to claim 1,
wherein the set of resources includes:
a first primary resource generated by the first operator and associated with the first operator;
a first secondary resource generated by the first primary resource and associated with both of the first operator and the first primary resource; and
a second secondary resource unassociated with both of the first operator and the first primary resource,
wherein when the first primary resource generates the first secondary resource, the resource management unit acquires a first time difference between a generation time of the first secondary resource and a manifest application time when a manifest is applied, and takes the first time difference as a first feature value of the first operator, and
when the second secondary resource is generated, the resource management unit measures a second time difference between a generation time of the second secondary resource and a manifest application time when a manifest is applied, and takes the second time difference as first resource information, and
wherein the relation determination unit performs a prescribed arithmetic operation using the first feature value and the first resource information to thereby calculate a first probability at which the second secondary resource corresponds to the first operator.

3. The operator management apparatus according to claim 2,
wherein the resource management unit acquires a name of the first primary resource and takes the name of the first primary resource as a second feature value of the first operator,
wherein when the second secondary resource is generated, the resource management unit acquires a name of the second secondary resource and takes the name of the second secondary resource as second resource information,
wherein the relation determination unit performs a prescribed arithmetic operation using the second feature value and the second resource information to thereby calculate a second probability at which the second secondary resource corresponds to the first operator, and
wherein the relation determination unit calculates a third probability at which the second secondary resource corresponds to the first operator, using the first probability and the second probability to thereby determine a corresponding relation between the first operator and the second secondary resource.

4. The operator management apparatus according to claim 1,
wherein in the application system, a third secondary resource is associated with the first operator, and a fourth secondary resource is associated with a second operator,
wherein the second operator is configured to receive data from the first operator in the application system,
wherein the operator management apparatus further includes a verification unit which verifies a corresponding relation between a resource and an operator, and
wherein the verification unit assigns a first service to the first operator,
assigns a second service to the second operator, and
confirms whether the third secondary resource and the fourth secondary resource are able to communicate through the first service and the second service to thereby verify a corresponding relation between the third secondary resource and the first operator and a corresponding relation between the fourth secondary resource and the second operator.

5. The operator management apparatus according to claim 4, further including an event detection unit which detects an event to the application system,
wherein when the event detection unit detects that an event changing a status of the fourth secondary resource from a first status to a second status is generated, the event detection unit notifies an instruction to change the behavior of the first operator to the first operator.

6. The operator management apparatus according to claim 5,
wherein the event is an updating generated about the fourth secondary resource or an abnormality generated about the fourth secondary resource, and
wherein the instruction to change the behavior of the first operator is an instruction to stop data communication of the first operator to the second operator.

7. An operator management method of a container orchestration platform, comprising the steps of:
creating application system configuration information designating a configuration of an application system implemented in a prescribed container orchestration platform and having a set of operators including at least a first operator;
deploying the application system to the container orchestration platform, based on the application system configuration information;
acquiring resource information about a set of resources including a first primary resource generated by the first operator and associated with the first operator, a first secondary resource generated by the first primary resource and associated with both of the first operator and the first primary resource, and a second secondary resource unassociated with both of the first operator and the first primary resource, the set of resources being generated by the set of the operator;
when the first primary resource generates the first secondary resource, acquiring a first time difference between a generation time of the first secondary resource and a manifest application time when a manifest is applied, and taking the first time difference as a first feature value of the first operator;
when the second secondary resource is generated, measuring a second time difference between a generation time of the second secondary resource and a manifest application time when a manifest is applied, and taking the second time difference as first resource information;
performing a prescribed arithmetic operation using the first feature value and the first resource information to thereby calculate a first probability at which the second secondary resource corresponds to the first operator;
acquiring a name of the first primary resource and taking the name of the first primary resource as a second feature value of the first operator;
when the second secondary resource is generated, acquiring a name of the second secondary resource and taking the name of the second secondary resource as second resource information;
performing a prescribed arithmetic operation using the second feature value and the second resource information to thereby calculate a second probability at which the second secondary resource corresponds to the first operator; and
calculating a third probability at which the second secondary resource corresponds to the first operator, using the first probability and the second probability to thereby determine a corresponding relation between the first operator and the second secondary resource.

8. The operator management method according to claim 7,
wherein in the application system, a third secondary resource is associated with the first operator, and a fourth secondary resource is associated with a second operator,
wherein the second operator is configured to receive data from the first operator in the application system,
the operator management method further including the steps of:
assigning a first service to the first operator and assigning a second service to the second operator, and
confirming whether the third secondary resource and the fourth secondary resource are able to communicate through the first service and the second service to thereby verify a corresponding relation between the third secondary resource and the first operator and a corresponding relation between the fourth secondary resource and the second operator.

9. The operator management method according to claim 8, further including the step of notifying an instruction to change the behavior of the first operator to the first operator when it is detected that an event to change a status of the fourth secondary resource from a first status to a second status is generated.

10. The operator management method according to claim 9,
wherein the event is an updating generated about the fourth secondary resource or an abnormality generated about the fourth secondary resource, and
wherein the instruction to change the behavior of the first operator is an instruction to stop data communication of the first operator to the second operator.

11. An operator management computer program of a container orchestration platform, which is stored in a computer readable storage medium, the operator management computer program allowing a computer to execute the steps of:
designating a configuration of an application system including a set of operators;
acquiring resource information about a set of resources generated by the set of operators;
using a feature value of a first operator included in the set of operators and the resource information, calculating a probability at which a first resource included in the set of resources corresponds to the first operator to thereby determine a corresponding relation between the first operator and the first resource.

12. The operator management computer program according to claim 11,
wherein the set of resources includes:
a first primary resource generated by the first operator and associated with the first operator;
a first secondary resource generated by the first primary resource and associated with both of the first operator and the first primary resource; and
a second secondary resource unassociated with both of the first operator and the first primary resource,
wherein the operator management computer program further includes the steps of:
when the first primary resource generates the first secondary resource, acquiring a first time difference between a generation time of the first secondary resource and a manifest application time when a manifest is applied, and taking the first time difference as a first feature value of the first operator;
when the second secondary resource is generated, measuring a second time difference between a generation time of the second secondary resource and a manifest application time when a manifest is applied and taking the second time difference as first resource information;
performing a prescribed arithmetic operation using the first feature value and the first resource information to thereby calculate a first probability at which the second secondary resource corresponds to the first operator;
acquiring a name of the first primary resource and taking the name of the first primary resource as a second feature value of the first operator;
when the second secondary resource is generated, acquiring a name of the second secondary resource and taking the name of the second secondary resource as second resource information;
performing a prescribed arithmetic operation using the second feature value and the secondary resource information to thereby calculate a second probability at which the second secondary resource corresponds to the first operator; and
calculating a third probability at which the second secondary resource corresponds to the first operator, using the first probability and the second probability to thereby determine a corresponding relation between the first operator and the second secondary resource.
